(19) United States
(12) Patent Application Publication
(10) Pub. No.: US 2016/0104086 A1
(43) Pub. Date: Apr. 14, 2016

(54) SYSTEM FOR SELECTING ENVIRONMENTALLY-SUSTAINABLE BUILDING PRODUCTS

(71) Applicant: Sphere E, Inc., Providence, RI (US)

(72) Inventors: Urs Peter GAUCHAT, Cambridge, MA (US); WIlliam Spence HARBER, Warwick, RI (US); Daniel WILLIAMS, Caversham (GB); Deborah DUNNING, Providence, RI (US); Eva Schmincke, Tubingen (DE)

(73) Assignee: Sphere E, Inc.

(21) Appl. No.: 14/974,678

(22) Filed: Dec. 18, 2015

Related U.S. Application Data
(63) Continuation-in-part of application No. 13/588,561, filed on Aug. 17, 2012.

(51) Int. Cl. G06Q 10/06; G06Q 50/08; G06Q 30/06

(52) U.S. Cl. CPC G06Q 10/06313; G06Q 30/0629; G06Q 30/0633; G06Q 30/0641; G06Q 50/08

(57) ABSTRACT

An enhanced system is provided to assist a building professional in selecting products for building projects which minimize environmental impact. Accurate data on many different building products that has previously been collected, categorized and subcategorized by product type is provided to the system. This information has previously been separated into ranks (spheres) based upon how well the data has been collected according to ISO Product Standard data requirements. A user may then interactively select values for the environmental impact parameters. Products matching the selected environmental impact parameter values are displayed, while those not matching the values are not displayed. The user may select various products. The amount of each selected product to be used on a project is acquired and used to weight the environmental impact. Costs and financial benefits are determined from the products used and a payback period is determined.

### CROSS-REFERENCE TO RELATED APPLICATIONS

This application is a continuation-in-part (CIP) of, and claims priority to co-pending U.S. patent application Ser. No. 13/588,561 filed Aug. 17, 2012 by Deborah Dunning entitled “Performance Reporting For Products and Services Using Web-Based Portals”, (the “Dunning Application”), the contents of which are hereby incorporated by reference into this patent application as if set forth herein in full. application Ser. No. 13/588,561 claims priority to U.S. provisional application nos. 61/413,830 filed on Nov. 15, 2010 and 61/663,023 filed on Jun. 22, 2012. U.S. patent application Ser. No. 13/588,561 is a CIP of U.S. patent application Ser. No. 13/295,619 filed on Nov. 14, 2011, now U.S. Pat. No. 8,275,630.

### STATEMENT REGARDING FEDERALLY SPONSORED RESEARCH

Not Applicable.

### BACKGROUND

1. Field of Invention

The present invention relates to a system for comparing and visualizing the environmental impact of various building products for a building project and more particularly to a system for comparing and visualizing environmental impact of various building products for projects and calculating their payback periods.

2. Description of Related Art

### Generally

When creating a building, there are many different types of products and/or materials which may be used. (Going forward, “product” will be considered a general term which also include materials used.) Some products have significantly different environmental impact than others. It is difficult to gather all of this information, determine which is accurate and complete, and display it to a builder or architect in a form which is easy to comprehend and make business related decisions.

It is difficult to manually make comparisons of the environmental impact of building products individually or within a project with multiple products to established product environmental impact benchmarks or other means of measuring and comparing environmental sustainability performance. A measure of environmental sustainability is the inverse of environmental impact. Higher environmental impact equates to lower environmental sustainability performance.

Currently Users must conduct manual reviews and manual statistical calculations of environmental impact data for the selection of building products. This includes reviewing data in multiple software applications, product websites, and published product materials (e.g. Environmental Product Declarations). This process is time consuming and inconsistent from product to product and project to project.

For example, if a building project has significantly more square meters of roofing than floor tiling, and their environmental impacts per unit are similar, then the environment impact of the roofing material will outweigh that of the tile. Therefore, one needs to also take into account the quantity being used, as well as its environmental impact.

Some products of the same type differ in terms of their energy savings which results in better environmental sustainability performance. It is common that products with higher cost, often yield higher energy reduction performance during their operational phase. For example, using windows with a higher “U” rating may initially cost more than other windows with a lower “U” rating. However, the higher “U” rating commonly results in a higher energy saving during window operation. Therefore, over time, these windows may result in significant energy savings which will far outweigh the additional cost of the windows. There are no systems currently known which compare the product specific lifetime energy reduction performance and cost of like products in order to assist in selecting building products.

Currently, there is a need to provide a process and software system that overcomes the problems described above.

### BRIEF DESCRIPTION OF THE DRAWINGS

The advantages of the system described in this application will become more apparent when read with the exemplary embodiment described specification and shown in the drawings. Further, in the accompanying drawings and description that follow, like parts are indicated throughout the drawings and description with the same reference numerals, respectively. The figures may not be drawn to scale and the proportions of certain parts have been exaggerated for convenience of illustration.

FIG. 1 is a listing of the “Environmental Impact Parameters” or “EIPs”, which may be also referred to as “Lifecycle Assessments” or “LCAs” and used interchangeably throughout this document, that are considered by the current invention.

FIG. 2 is a schematic block diagram of a system for assisting a user in selecting products based upon environmental impact as well as costs, which also calculates a payback period, according to one embodiment of the current invention.

FIGS. 3A and 3B together are a flowchart generally indicating the steps of one embodiment of the present invention.

FIG. 4 is an illustration of a screen shot of one embodiment of the current invention illustrating the interactive display.

FIG. 5 is a screen shot of a more detailed graphical comparison of insulation products.

FIG. 6 is a more detailed illustration of the interactive display step of FIG. 3A.

FIG. 7A and FIG. 7B together are a spreadsheet representing the information calculated by the current invention.

### SUMMARY

The current invention may be embodied as a system for selecting building products based upon environmental and economic factors having a database with information, which preferably is vetted information for a plurality of products categorized by product type having information for a plurality of environmental impact parameters for the entire lifecycle of each product. The database also having a custom calculated benchmark for each lifecycle stage environmental impact parameter for a given subcategory. The system includes a user interface capable of interactively receiving information from a user and providing graphical displays to the user. It also includes a filtering process coupled to the user interface and the database, capable of receiving the products selected by the user for comparison, and acquiring information from the database for these selected products. A building scenario device coupled to the user interface, filtering device and the database, functioning to receive the information selected by the filtering device, receive the benchmark for each environmental impact parameter for a selected products from the database, and create a graphical display of the information for each environmental impact parameter against its corresponding benchmark for each selected product that is displayed on the user interface, allowing the user to select products to be used in a project. A payback device is coupled to the user interface, and the filtering device, which operates to receive the cost information and lifetime energy cost information for the selected products, and calculate how long it would take for the energy cost to equal the a difference in costs (if at all); and provides the results to the user interface for display.

### DETAILED DESCRIPTION

The present invention will now be described in detail by describing various illustrative, non-limiting embodiments thereof with reference to the accompanying drawings. The invention may, however, be embodied in many different forms and should not be construed as being limited to the illustrative embodiments set forth herein. Rather, the embodiments are provided so that this disclosure will be thorough and will fully convey the concept of the invention to those skilled in the art. The claims should be consulted to ascertain the true scope of the invention.

### 1. Theory

There are accepted Work Breakdown Structure (WBS) for defining categories and subcategories of building products, such as the Construction Specification Institute (CSI) codes in the United States. Manufacturers offer a variety of different products in various categories of building products, such as ceiling tiles that are subdivided into subcategories, such as energy efficient ceiling tiles. Each category and subcategory have their own CSI Code.

For the description of this application, there will be references to CSI Codes; however, please note that there are other equivalent accepted WBS standards used in the United States and other countries that would be compatible with the current invention. This invention may easily be adjusted to use those WBS standards.

Many product manufacturers publish information on the various products they sell. These are published with varying degrees of completeness and accuracy. Some manufacturers provide product information that is very thorough and include substantial environmental impact information according to one or more ISO Product Standards, such as ISO 14040, 14044, 14025, and other relevant product standards while other manufacturers do not provide a full set of information. U.S. Pat. No. 8,275,630 B2, Sep. 25, 2013, issued to D. Dunning “Performance Reporting for Products and Services Using Web-Based Portals” described a measure of how well data complies with ISO Product Standard data requirements-rated by “Spheres”. In the Dunning Patent, Sphere 1 was the rating given to data which complied with most of the ISO Product Standard Requirements, while Sphere 5 was assigned to data which complied with few or no ISO Product Standard data requirements. A reversal of ranking terminology took place in 2014 from the original Patent. Since that time, the scale has been reversed so that now Sphere 5 is for data which has the highest compliance with ISO Product Standard Requirement, and Sphere 1 was assigned to data which does not comply with-ISO Product Standard data requirements. In the current application, we are using the latter system in which Sphere 5 is the most compliant data and Sphere 1 is the least compliant data.

Ms. Dunning is also named as the Inventor of pending U.S. patent application 2013/0124269, published May 16, 2013, (the “Dunning Patent Application”) that is hereby incorporated by reference as if set forth in its entirety herein, that collects building product data for a plurality of CSI Codes and EIPs and Product LCAs that has been analyzed, vetted and categorized into spheres according to the Dunning patent listed above. Data from the most compliant spheres are combined to calculate benchmarks, standards, thresholds or other comparisons (collectively referred to as “benchmarks”) for the EIPs of each CSI Code. Since the data used is from products that are leading the industry in their low environmental impact, they are registered as a U.S. Trademark “LEADERSHIP BENCHMARKS” and described in the Dunning Patent Application.

### Implementation

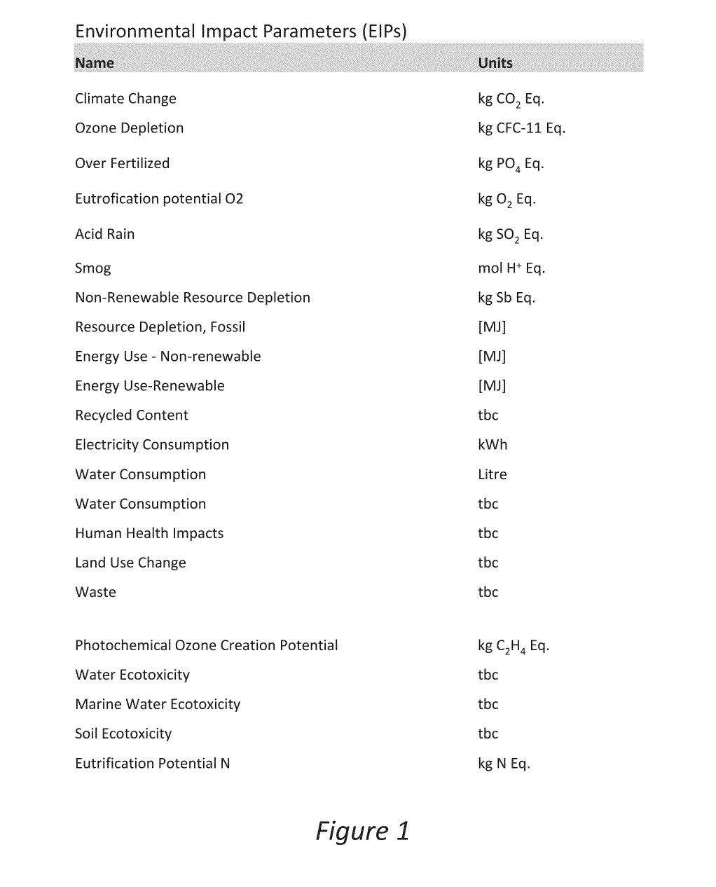

FIG. 1 is a listing of the EIPs that are analyzed by the current invention. The units used vary but cover the entirety of the International System of Units (SI). For example, many impacts are communicated in terms of kilograms (kg), meters (m), liters (l), and kilowatt hours (kWh).
CO₂=Carbon Dioxide,
CFC-11=Trichlorofluoromethane,
PO4=a phosphate radicle,
O₂=Oxygen,
SO₂=Sulphur Dioxide,
H⁺=Hydron,
Sb=Antimony,
MJ=mega joule,
kWh=kilowatt-hour,
C₂H₄=Ethylene,
N=Nitrogen.

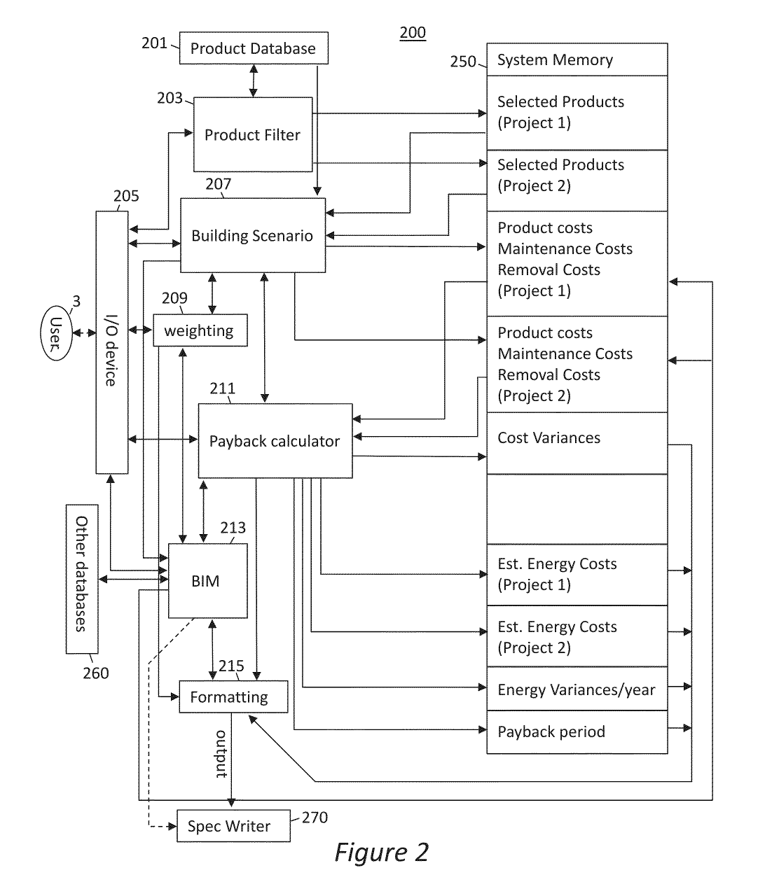

FIG. 2 is a schematic block diagram of a system for assisting a user in selecting products based upon environmental impact as well as costs that calculate a payback period according to one embodiment of the current invention.

In FIG. 2, compliant product information is acquired and stored in a database 201. This information includes cost information as well as values for at least a subset of EIPs listed in FIG. 1.

These EIP values reflect the environmental impact of various chemical entities created during manufacturing of each unit of the product. Their impact upon the environment is standardized by equating them to amounts of CO₂, CFC-11, PO₄, SO₂, moles of H+, etc., having the same environmental impact produced for each unit of the product manufactured.

A User 3 interactively operates an Input/Output (I/O) device 205. Initially, the user 3 may choose an existing building project or define a new one, The User 3 may also select a category/subcategory/sub-subcategory, etc. (CSI Code) defining a type of product upon which the user would like to select or adjust products. (There may be several layers in the hierarchical breakdown.)

Products for a defined CSI code in the Product Database 201 have information relating to one or more EIPs. A Product Filter 203 is coupled to the Product Database 201 and determines EIPs that are common to the Products of the selected CSI Code and identifies them to the I/O device 205. I/O device 205 provides a means for adjusting the Environmental Impact Parameters on the I/O device 205 provides a means for selecting LCA Impacts. The I/O device may use a ‘slider’ feature to select a value for each EIP. The Product Filter 203 coupled to the I/O device 205 interactively receives the values set for each EIP on the I/O device 205, and identifies products of the selected CSI Code having EIP values that equal or exceed these EIP values. These products are then listed to the User 3 on the I/O device 205. The user 3 may again change one or more of the EIP values. This would cause the process to repeat with the different values and either make additional products appear on the I/O device 205, or remove products that were previously being displayed. This gives the interactive impression of adjusting the EIP values to change the product listing on a display of the I/O device 205.

The user 3 selects all or a subset of the products being displayed for a more detailed analysis.

An illustrative example would be helpful. User 3 chooses a CSI code for energy efficient windows. There are 35 products which meet the CSI code in the Product Database 201 that are displayed in list form on a display for I/O device 205. All of these have information for the EIPs “Climate Change”, and “Energy Use—Non-renewable”, among others. The user 3 adjusts the adjustment device on the I/O device 205 to set a value for “Energy Use” at 30% above the benchmark and at 20% above a benchmark for “Energy Use—Non-renewable” on the I/O device 205. This causes Product Filter 203 to immediately find those products in the Product Database 201 which meet or exceed both of the values set for these EIPs. There may be, for example, 5 products listed which meet or exceed the criteria set. This may be repeated for many iterations by simply adjusting the adjustment device.

If the user changes the value on the adjustment device, the Product Filter 203 immediately goes to the Product Database 201 and finds products meeting the new EIP values. For example, there now may be 8 products listed on the display of the I/O device 205.

The user 3 may select certain entries for a more detailed analysis. This may include all of the EIPs graphically displayed with relation to a benchmark or other metrics for each of the EIPs.

For example, 8 products are displayed. Several products, such as products 5, 7 and 8, may be selected for a more detailed display. The greater detail includes a full listing that is typically a graphical display of the EIPs for each product in a comparison. Other information, such as any certifications may also be displayed to aid the user 3 in selecting products.

A product or series of products may be selected to be used in the current project (Project 1) and is stored in system memory 250 coupled to Product Filter 203.

This may be repeated for many CSI codes and also for an additional project, such as Project 2. The selected products for each of Projects 1 and 2 are stored in system memory 250.

User 3 may interact with a building scenario device 207 through I/O device 205.

The mass and/or quantity of the products used on a project can vary between products and categories of products. This difference makes the environmental sustainability determinations for certain categories of products more important than others.

User 3 may provide manual weighting through I/O device 205 to weighting device 209. Alternatively, the user 3 may interface through I/O device 205 to a Building Information Modeling software system (BIM) 213 which may be a standard system such as that marketed by Autodesk (“Building Design Suite”) or Vectorworks, Inc. (“Vectorworks Architect”). BIM 213 may be connected to various databases 260. Using the BIM system, the user 3 may then select or design structures and may derive the actual amount of each product to be used from a definition of a structure (blueprints).

Building scenario 207 is coupled to system memory 250 and receives the information regarding the selected products for one or more projects. Building scenario 207 also receives the product weighting from weighting device 209 that is set manually by a user through I/O device 205.

Alternatively, instead of manual weighting, BIM 213 may provide actual amounts required for a project to Building scenario 207. Based upon the actual amounts used, the Building Scenario 207 can calculate potentially the monetary lifecycle cost for each product using the quantity data and data stored or supplied on the per unit cost of the product. (The product lifetime is one of the fields of the product data that comes from the Product database 201.) The user or BIM system may optionally supply product maintenance and product end of life monetary costs which are then included within the total cost. The differences in costs between both projects results in Cost Variance that is stored in System Memory 250.

The time required to pay back additional product cost relative to its energy reduction performance are typically done manually. It would be beneficial if a system could automatically calculate the payback monetary cost and payback period relative to its energy reduction performance for the selected building product(s) and sum of all products within a project.

A payback calculator 211 receives the total lifecycle costs for projects 1 and 2 and calculates a cost variance.

Payback Calculator 211 receives information from BIM 213 on the size and construction of the building of Project 1. Payback Calculator 211 also receives information from BIM 213 on the size and construction of the building of Project 2. The BIM system automatically or the user manually enters information on the use phase energy consumption of the product(s) over its lifetime, the system then automatically calculating a variance between Project 1 and Project 2. Using the product information and energy variance for each project and with the information received from BIM, Payback Calculator 211 estimates monetary energy costs for Project 1 and for Project 2, using a pre-determined energy cost value for the user which are stored in system memory 250.

Payback Calculator 211 calculates the Estimated Energy Costs per unit of time (time set to months or years of the product lifetime) to result in the Energy Variances/unit time.

The Payback Calculator 211 can then determine how many time units it will take the Energy Variances/unit time to equal the Cost Variance. This is referred to as the ‘payback period’ and is stored in System Memory 250.

This much of the information described currently requires manual input into a project specification writing system, it would be beneficial to format and directly port the information into a building specification writing system.

A formatting device 215 is connected to and receives information from the building scenario device 207, weighting device 209, payback calculator 211, and BIM 213 to reformat the information and provide the reformatted information to a building specification writer (or “spec writer”) 270 running enterprise software that is used for writing building specifications. Spec writer 270 may implement commercially available software, such as e-Specs by InterSpec.

Alternatively, some or most of the information for the Spec Writing device will

This example compares two projects each having a product selected for a plurality of CSI Codes.

In an alternative embodiment, multiple products of the same CSI Code may be compared to determine a payback period of one product vs. another.

Alternatively, the user 3 may interact with the system to replace products by a similar one from another manufacturer, to compare products and to perform other “what if” scenarios to interactively calculate the environmental impacts. The system could allow the user to replace one or more products but keep the same, or higher environmental sustainability performance.

The system will also indicate the products of a project which contribute the most to the environmental sustainability performance. For example, a project may have many windows, so only a small increase in the environmental sustainability performance of the windows will result in large over-all environmental sustainability performance increase.

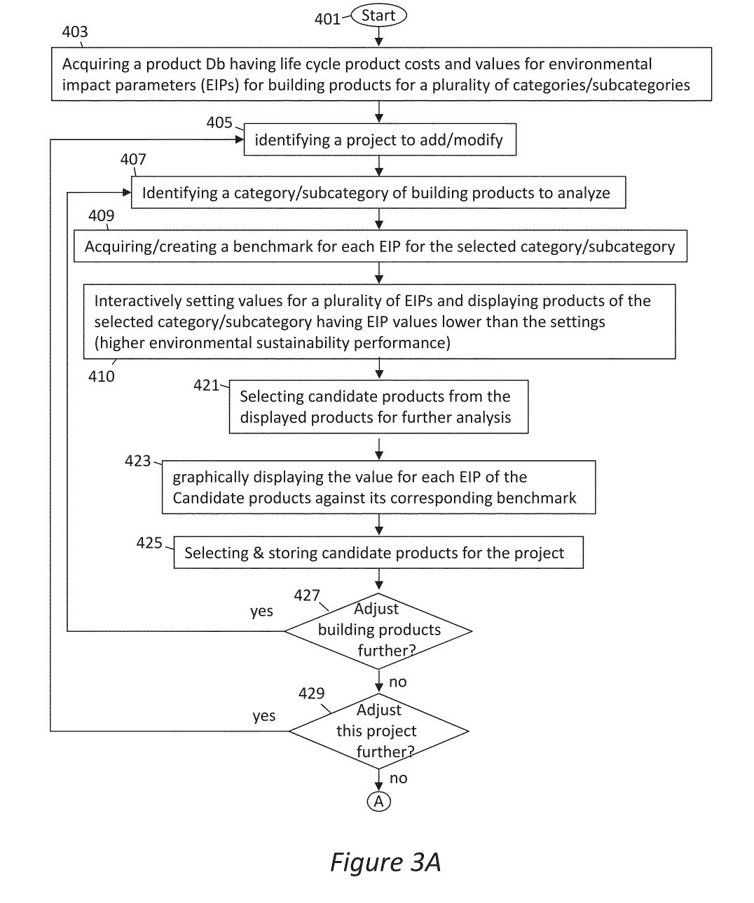

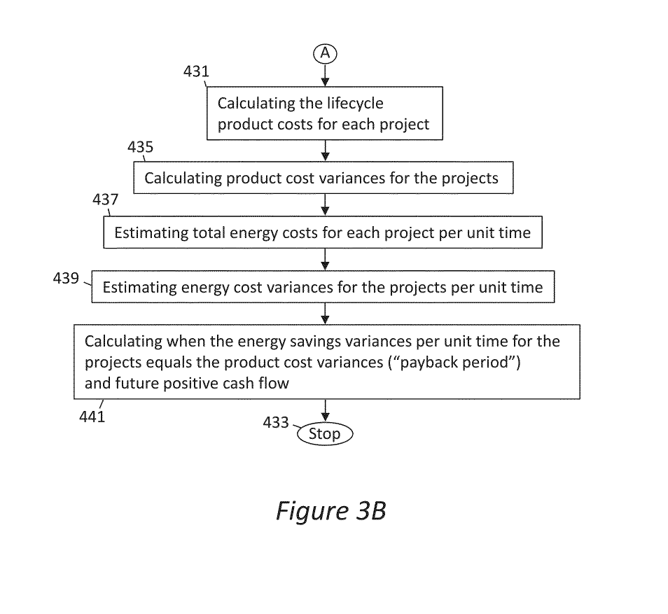

FIGS. 3A and 3B together are a flowchart generally indicating the steps of the functioning and process of one embodiment of the present invention.

The process begins at step 401 of FIG. 3A. In step 403, a database is acquired of building products for a plurality of CSI Codes each having life cycle product costs and values for at least one Environment Impact Parameter (EIP) that is stored in memory.

In step 405 a user identifies an existing project to modify or create a new project.

In step 407, the user identifies which CSI Code or Product Type (category/subcategory/ . . . etc.) on which the user will be working.

In step 409, the user acquires benchmarks, or creates benchmarks for each EIP analyzed for the selected CSI Code. These may be pre-stored in a database, or are derived from the product information stored in the database. There are various different types of benchmarks which may be employed here.

One of the best methods of determining a benchmark is referred to above in the Dunning Patent Application, and is the preferred method. This employs “Leadership Benchmarks”.

Other benchmarks may be created from information acquired from the database for each specific product type and for each EIP. For example, one may have 40 different products of a given product type. This information may be analyzed to insure that they have a desired level of completeness and optionally closely follow an accepted standard, such as an ISO environmental standard. Only those records which meet the criteria will be referred to as “acceptable data” and may be used in determining the benchmarks.

In this example, of the 40 original records, only 32 of them were deemed to be “acceptable data” and will be used in determining the benchmark.

In this example, of the 32 records, only 30 include information relating to the Climate Change EIP. All or a portion of these 30 may be combined to determine a benchmark for this product type and this EIP. For example, all may be averaged to make an average benchmark. The top 20% may be used and averaged into a top 20% benchmark. There are also benchmarks which throw out the high and the low values and average the remaining values. Many different types of known benchmarking methods may be used to determine one or more benchmarks to be used as a guide when comparing the environmental sustainability performance of a product or group of products.

In addition, each product EIP may contain multiple EIP values split across the product lifecycle (e.g. total, transport, manufacturing, etc.). The above process is sorted according to the relevant lifecycle stage.

In step 410, the user interactively adjusts either virtual or physical sliders, knobs or other adjustment devices each associated with at least one EIP, to alter the value of that EIP. In the preferred embodiment, the database is immediately scanned to find products in the database having EIP values which meet or exceed the values of the EIPs set by the adjustment devices. These are immediately displayed on a display device to the user. The user may immediately adjust one or more EIP values to see a different set of products being displayed. This interactive method of display is very efficient and effective.

Furthermore, the user may also select a desired lifecycle stage to analyze EIPs and Products. For example, selecting the ‘Transport’ phase only would filter out firstly any products that do not have that lifecycle value and secondly update EIP values and benchmarks to the relevant ‘Transport’ EIP.

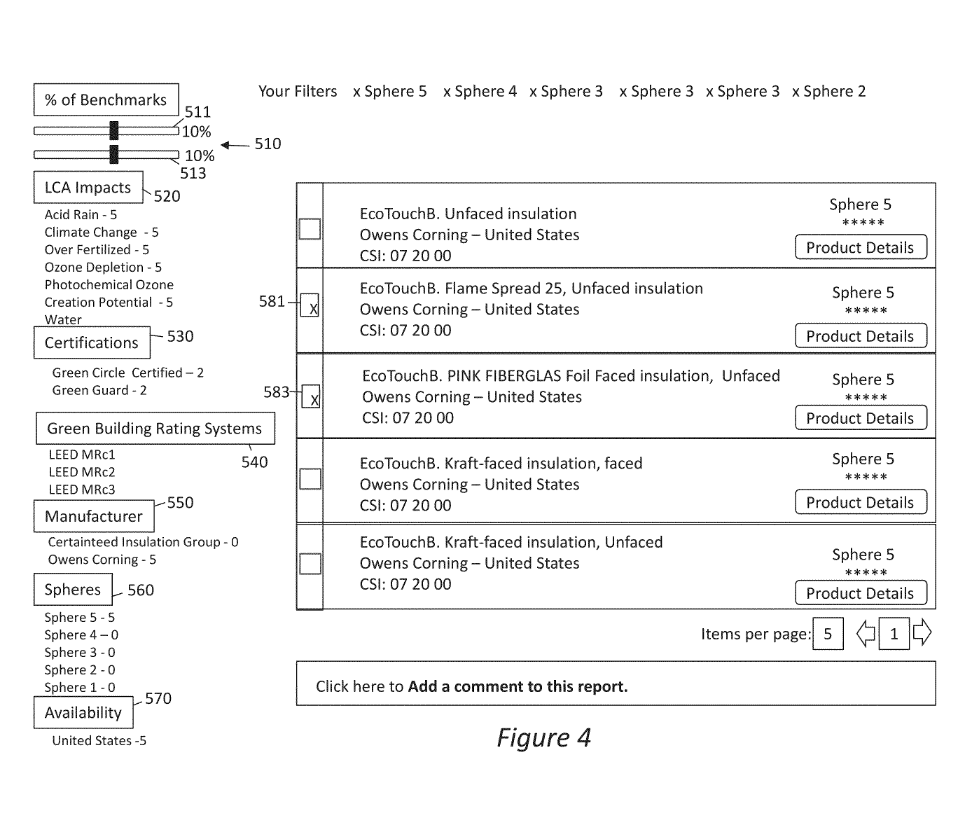

FIG. 4 is an illustration of a screen shot of one embodiment of the current invention illustrating the interactive display. This screen pertains to a product type having a “category/subcategory/sub-subcategory . . . ” of “building envelope/insulation/fiberglass batts” equating to a CSI Code of “07 20 00”.

Adjustment device 510 is shown here as sliders 511 and 513, each pertaining to an EIP. For example, slider 511 may pertain to “Climate Change” and slider 513 may pertain to “Ozone Depletion”. Positioning a handle of the slider in the center (at the benchmark line) will pertain to EIP values up to and including a value equal to the benchmark value for this product type and this EIP.

Pushing the handle to the right will increase the values up to a maximum. Pushing the handle to the left will decrease the values down to a minimum value. The slider may be set up in percentages of environment impact performance relative to a benchmark, as it is in FIG. 4. At the center, all products with an EIP value equal to, or lower than the benchmark value, will be displayed. (Lower EIP values equate to higher environmental impact performance.) The range set up for this example goes from a low of −100% below the benchmark to a maximum of +100 percent above the benchmark, it also includes an ‘any’ position to disregard any value preference. In FIG. 4, the sliders 511, 513 are both set to 10% above the benchmark. This should cause products exhibiting at least 10% or higher environmental impact performance to be displayed, as shown FIG. 4.

Additional information is shown for Life Cycle (L.C.A.) Impacts in section 520 (which have also been referred to as EIPs) followed by a number indicating the number of products also being 10% above the benchmark for these L.C.As.

The “Certification” section 530 indicates various certifications and a number indicating the number of products that fit the criteria set by the sliders 511, 513 that also have these certifications.

The “Green Building Rating System” section 540 indicates the number of products that fit the criteria set by the sliders 511, 513 that also meet the standards for the “Green Building Rating System”.

The “Manufacturer” section 550 indicates the manufacturers of the products that fit the criteria set by the sliders 511, 513.

The “Spheres” section 560 indicates how complete and compliable to the ISO Product Standards the information is relating to the products that fit the criteria set by the sliders 511, 513.

Section 570 lists where (in which countries) the products that fit the criteria set by the sliders 511, 513 are available.

In step 421, the user then selects candidate products to examine further. This is performed by clicking the boxes 581 and 583 in FIG. 4 to select the two products

More detailed information of the EIPs for each of the candidate products is displayed to the user in step 423. The information relating to the EIPs for this product is displayed with reference to benchmarks for each EIP this product type.

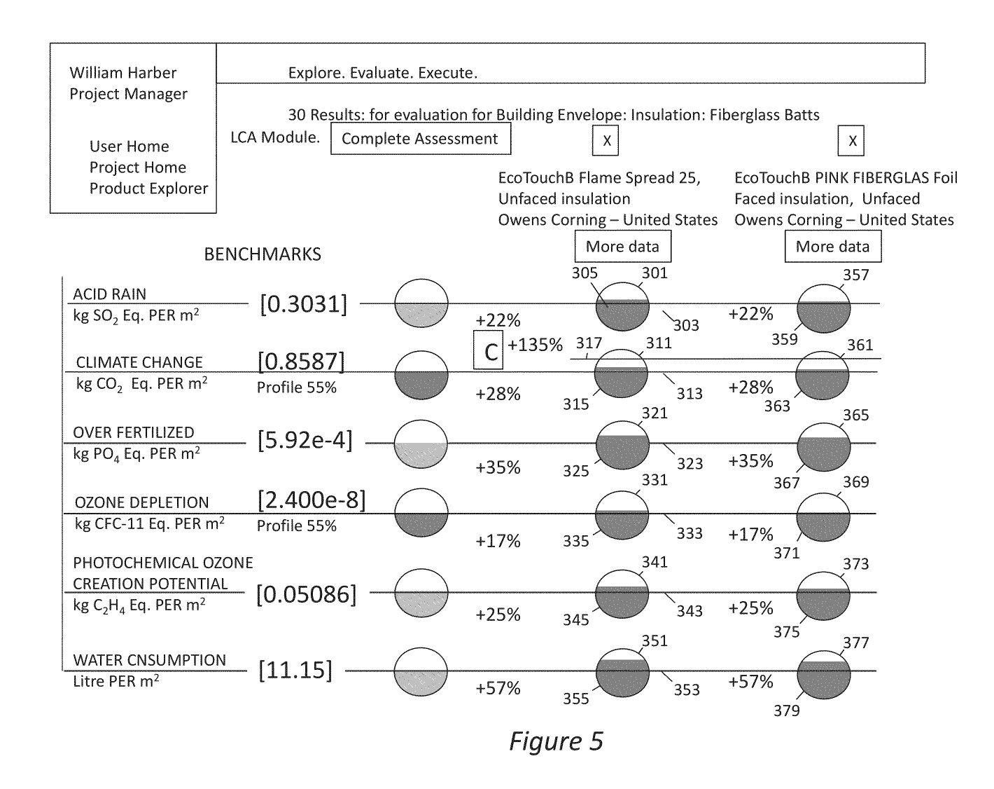

FIG. 5 is a screen shot of a more detailed graphical comparison of two products, EcotouchB, Flame Spread 25, Unsurfaced insulation, and EcoTouchB PINK FIBERGLAS Foil

Faced insulation, Unfaced both made by Owens Corning Company of the United States. The environmental effect of manufacture, use and removal of this product over the product's lifecycle is reflected in six EIPs shown. These are expressed as the equivalent impact upon the environment as an amount of an equivalent chemical entity per unit of the product. Since this product type is insulation, the units are expressed in square meters of the product.

The first EIP is “Acid Rain” expressed in kilograms of Sulphur dioxide (SO₂) equivalent per square meter of the product used. This indicates that creating, using and removing the listed product would have the same effect on the amount of acid rain produced as putting 0.3031 kilograms of SO₂ and releasing it into the atmosphere for every square meter of the product produced and used. To the far right is a circle 301 having a shaded region 305 that fills circle 301 from the bottom to 72% filled. There is a horizontal black line 303 which would align with a horizontal diameter. This is the benchmark line 503. The shaded region 305 is 22% above the benchmark line 303 for this product and for this EIP (Acid Rain).

Similarly, the next EIP for this product is “Climate Change” expressed in kilograms of CO₂ equivalent per square meter. The lifecycle impact of this product is 0.8587 kilograms of CO₂ released into the atmosphere for each square meter of the product used. On the far right the circle 311 has a shaded region 315 that fills 78% fills of the circle 311. A benchmark line is 313. The shaded region is 28% above the benchmark line 313, but is below a certification line 317. If the shaded region 315 was equal to or above the certification line 317, then it could be stated that this product meets or exceeds this certification benchmark for this EIP.

“Over Fertilized” is the next EIP expressed in kilograms of phosphates (PO₄) equivalent per square meter of the product. It also has a circle 325, baseline 323 and shaded region 325 at the far right. The shaded region 325 fills 85% of the circle 321 and represents 0.000592 kilograms of PO₄ released into the environment. This is 35% above the benchmark line 323.

“Ozone Depletion” is expressed in kilograms of CFC-11 equivalent per square meter. The circle 331 at the far right is 67% filled by shaded region 335 representing 2.4×10-8 kilograms of CFC-11 for every square meter over the lifecycle of the product. This is 17% above the benchmark line 333.

“Petrochemical Ozone Creation Potential” is expressed in kilograms of C₂H₄ equivalent per square meter. In this case the lifecycle environmental impact of each square foot of the product will be equivalent to releasing 0.0586 kilograms of C₂H₄ into the environment. At the far right, a circle 341 is 75% filled by the shaded region 345. The shaded region 345 is 25% above the benchmark line 343.

“Water Consumption” is expressed in liters per square meter of the product. The lifecycle of the product requires 11.15 liters of water for every square meter of the product over its lifecycle. This is shown by the circle 351 on the far right that is 97% filled by the shaded region 355. The shaded region 355 is 57% above the benchmark line 353. This indicates that this product rates very well for conserving water.

The comparison product on the right also has circles 357, 361, 365, 369, 373 and 377 which are partially filed with their corresponding shaded regions 359, 363, 371, 375 and 379 each corresponding to the EIPs of the first product. This allows for a head-to-head comparison of several products regarding their environmental sustainability performance.

Only six of the environmental impact parameters (EIPs) are considered in FIG. 5. The system only displays those which have information that can be compared. Therefore, different product types will bring up different combinations of EIPs. Most combinations of the EIPs shown in FIG. 1 may be displayed for various product types.

Returning back to FIG. 3A, in step 425 after analyzing the EIP information of the candidate products, the user is allowed to select which products will be used in a project. These can be stored in the system memory.

In step 427, it is determined if the user would like to analyze other products to replace those selected for projects or to add other products to a project. If so (“yes”), then steps 407 to 425 are repeated. If not (“no”), then processing continues at step 429.

In step 429 it is determined if the user would like to further modify this project, or add another project. If so (“yes”), then steps 405 to 427 are repeated. If not, (“no”), then processing continues at step 431 of FIG. 3B.

The BIM system has a structural model of the building desired to be built. This may be a commercial product that may interface with the remainder of this system, or custom software that is part of the system. It functions to interact with the user as an architectural tool to design and develop an architectural model of a building. One of its functions is to define the product types required and the total products required for each product type.

In step 431, the total products required for each product type are acquired from the BIM system and are multiplied by the cost per unit of each corresponding selected product to produce the product costs for a given project. This may also be done for a second, comparison project.

The differences in costs of products between two projects is calculated as cost variances in step 435.

In step 437, using the information of building size, weight, mass and other information from BIM, the approximate energy costs for each building project are calculated and stored.

In step 439, the energy costs between the two projects (the energy cost variance) is calculated. This is expressed in cost per unit time.

In step 441, it is determined how long it will take for the energy cost variance to equal the product cost variance. This is referred to as the “payback period”. The time is usually expressed in years. Therefore, if one selects products for Projects 1 and 2 and those of Project 2 are more expensive and more energy efficient, and the payback period is determined to be 8 years. This means that all the energy cost savings after 8 years is profit (“future positive cash flow”) while resulting in a building which has a lower impact upon the environment. The process stops at step 433.

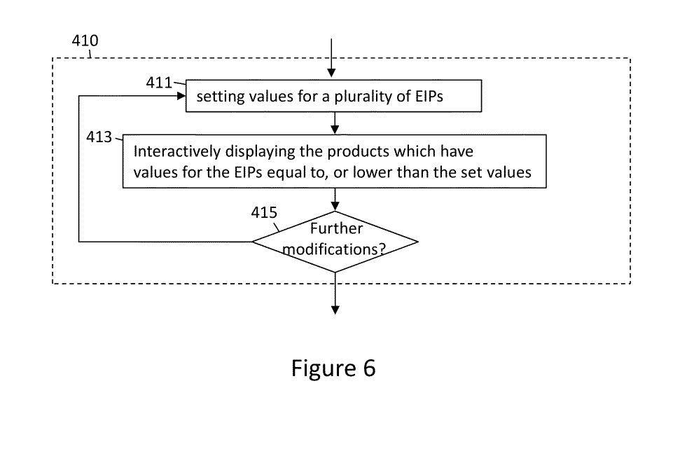

FIG. 6 is a more detailed illustration of the interactive display step 410 of FIG. 3A. In step 411, the user sets at last one adjustment device to a position that defines at least one EIP value.

In step 413, the products meeting or exceeding the performance for all of the EIP values set will be displayed.

In step 415, it is determined if the user has changed any of the EIP values for display. If so (“yes”), processing continues at step 411. If not (“no”), then processing continues at step 421 of FIG. 3A.

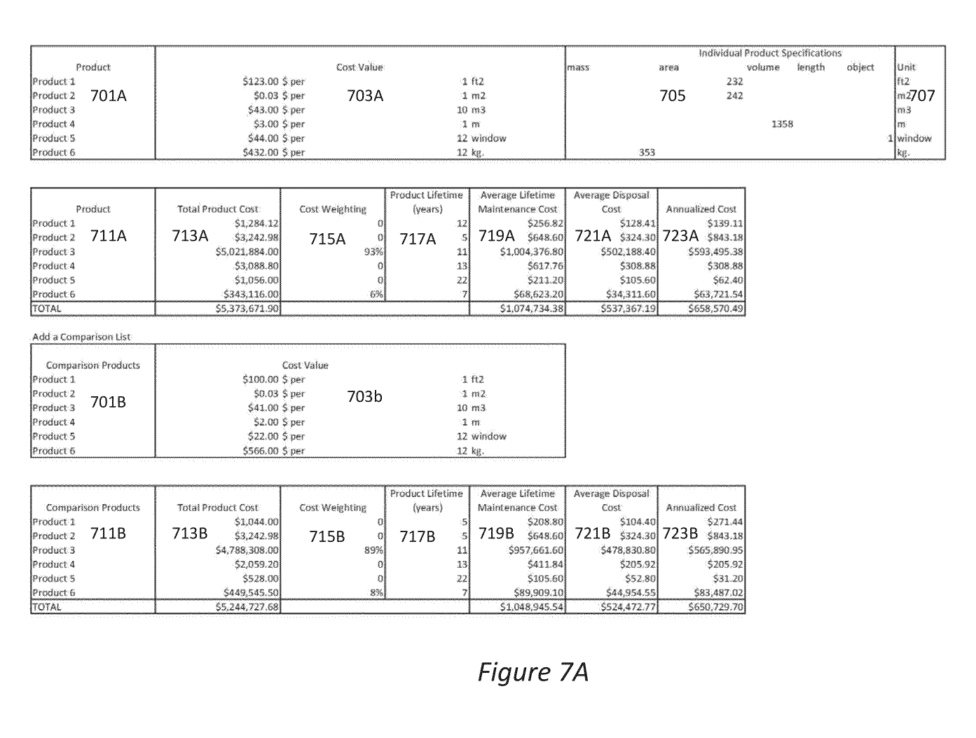

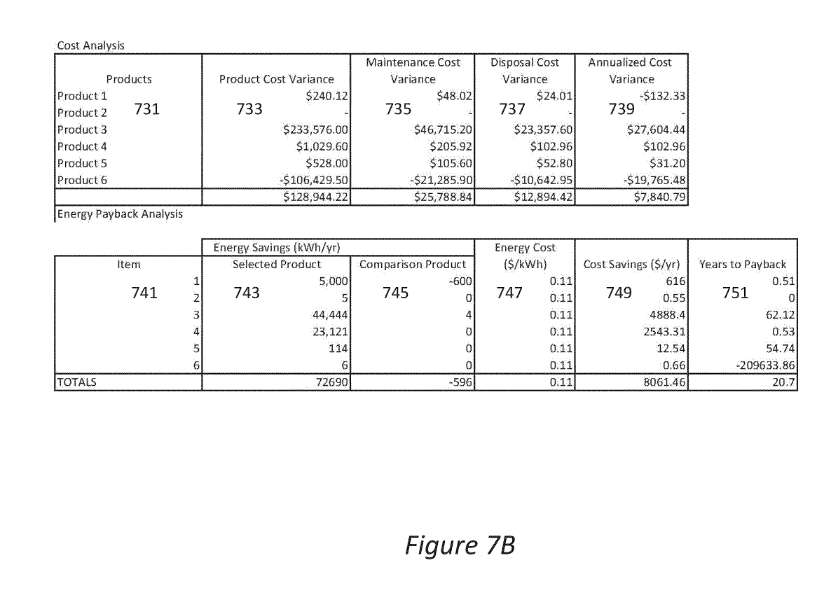

FIGS. 7A and 7B together represent a spreadsheet having information calculated by the current invention. The block of data identified as 701A, 701B indicates two different sets of products selected to be analyzed. The products of block 701A represent various product types (CSI Codes). “Product 1” of blocks 701A and 701B represent different products of the same product type (CSI Code). Similarly, “Product 2” of blocks 701A and 701B represent different products of the same product type (CSI Code). The same is true for “Product 3” through “Product 6”.

The products listed in block 701A are the same as those in block 711A. Similarly, the products of 701B are the same as those in block 711B.

Block 703A indicates the cost per unit to purchase each product. It also indicates the units of measurement being square feet, square meters, cubic meters, per 10 meters, by item (window), and by 12 kilograms.

Block 703B indicates the cost per unit to purchase each of the second set of products for the same product types of block 703A.

Block 705 indicates the total amounts of each product to be used, and block 707 indicates their units of measurement.

Blocks 713A, 713B indicate the total product cost being the cost per unit multiplied by the units used, of the products of blocks 711A, 711B, respectively.

Blocks 715A, 715B show the percentage of the total cost attributed to each product in the “cost weighting” blocks 715A, 715B, respectively. The “product lifetime (years)” is taken from the product database and is represented by blocks 717A, and 717B.

The “Average lifetime maintenance cost” of blocks 719A, 719B is determined for each product by multiplying maintenance costs per year by the values of block 717A, 717B, respectively.

The “Average disposal costs” 721A, 721B are calculated by the disposal cost per unit multiplied by the number of units being used from blocks 705 and 707.

The “Annualized cost” of block 723A is determined by adding the values of block 713A “Total product costs” with the values of block 719A “Average lifetime maintenance costs” with the values of 721A “Average disposal costs” and dividing the sum by 717A “product lifetime (years)”.

Similarly, the “Annualized cost” of block 723B is determined by adding the values of block 713B “Total product costs” with the values of block 719B “Average lifetime maintenance costs” with the values of 721B “Average disposal costs” and dividing the sum by 717B “product lifetime (years)”.

Referring now to FIG. 7b, the products are listed in block 731, and the “Product cost variance” of block 733 is determined by subtracting the values in block 713B from the values in block 713A for each of the products. Similarly, the “Maintenance cost variance” of block 735 is determined by subtracting the values in block 719B from the values in block 719A for each of the products. The “Disposal cost variance” of block 737 is determined by subtracting the values in block 721B from the values in block 721A for each of the products. The “Annualized cost variance” of block 739 is determined by subtracting the values in block 723B from the values in block 723A for each of the products.

Block 741 represents the product types. In block 743 the energy savings per unit product of blocks 701A and 711A is acquired from the product database and is multiplied by the amount of each product in blocks 705 and 707 to result in “Energy savings (kWh)” in block 743. Similarly, the energy savings per unit product of blocks 701B and 711B is acquired from the product database and is multiplied by the amount of each product in blocks 705 and 707 to result in “Energy savings (kWh)” in block 745.

Multiplying the values of block 743 “Energy Savings (kW/year)—Selected Product” by those of block 747, “Energy Cost ($/kWh), results in the energy costs of the selected products of blocks 701A, 711A. Multiplying the values of block 745 “Energy Savings (kW)—Comparison Product” by the “Energy Cost ($/kWh)” of block 747 results in the “Cost Savings ($/year)” of block 749 due to reduced energy usage.

It is then a simple task to add the “Product Cost Variance” of block 733 to the “Maintenance Cost Variance” of block 735 and the “Disposal Cost Variance” of block 737 to result in the total cost variance for each product and dividing this by the cost savings per year in block 749 to result in the “Years to Payback” values in block 751. Product type 3 has a payback period of 62.32 years in block 751, whereas product type 1 only has a payback period of a little more than a half of a year. This tool is very efficient and effective at aiding designers and architects in choosing environmentally-friendly products.

Any or all of the above calculations and results may be displayed to the user.

While the present disclosure illustrates various aspects of the present teachings, and while these aspects have been described in some detail, it is not the intention of the applicant to restrict or in any way limit the scope of the claimed systems and methods to such detail. Additional advantages and modifications will readily appear to those skilled in the art. Therefore, the teachings of the present application, in its broader aspects, are not limited to the specific details and illustrative examples shown and described. Accordingly, departures may be made from such details without departing from the spirit or scope of the teachings of the present application. Moreover, the foregoing aspects are illustrative, and no single feature or element essential to all possible combinations may be claimed in this or a later application.

What is claimed is:

1. A system for selecting building products based upon environmental and economic factors comprising:
a. a database having prestored information for a plurality of products categorized by product type having information for a plurality of environmental impact parameters, as well as well as monetary cost information for the entire lifecycle of each product, the database also having a benchmark for each environmental impact parameter for a given category and subcategory;
b. a user interface capable of interactively receiving information from a user and providing graphical displays to the user;
c. a filtering device coupled to the user interface and the database, capable of receiving the products selected by the user for comparison, and acquiring information from the database for these selected products;
d. a building scenario device coupled to the user interface, filtering device and the database, functioning to receive the information selected by the filtering device, receive the benchmark for each environmental impact parameter for a selected group products from the database, and create a graphical display of the information for each environmental impact parameter against its corresponding benchmark for each selected product that is displayed on the user interface, and allows the user to select products to be used in a project;
e. a payback device coupled to the user interface, and the filtering device, which operates to receive the cost information and cost savings information for the selected products, and calculate how long it would take for the cost savings to equal the a difference in costs;
and provides the results to the user interface for display.

2. The system of claim 1 further comprising:
a. a BIM system which provides the total quantities of each of the product subcategories to be used in a project; and wherein
b. a project manager coupled to the user interface, the BIM, and the filtering device, adapted to operate with the user interface and the filter device to allow the user to select at least two products of a project and provide the selected
c. wherein the payback device is capable of determining costs for each product in the project and the total cost for all project products, and to calculate how long it would take for the cost savings of products selected for a project to equal the difference in costs for the entire project; and provides the results to the user interface for display.

3. The system of claim 2, wherein the project manager functions through the user interface to interactively identify and store products selected for use in at least one project wherein each project includes a plurality of products.

4. The system of claim 3 wherein the project manager interacts through the user interface with the user to allow the user to define more than one project, and the project manager causes the payback device to calculate how long it would take for the cost savings of products selected for each project to equal the a difference in costs for that project; and provides the results for the plurality of projects to the user interface for display.

5. The system of claim 1 wherein the user interface employs at least one variable input device in the user interface such that a value of one parameter may be adjusted as user interactively adjusts the variable input device to a setting being a percentage of a maximum setting that multiplies the maximum value for this parameter by the percentage to result in the setting value.

6. The system of claim 1 wherein the user interface employs slider input devices in the user interface such that a value of one parameter may be adjusted as user interactively adjusts the slider to a position being a percentage of a total slider distance between a minimum and maximum position that multiplies the maximum value for this parameter by the percentage to result in the setting value.

7. The system of claim 5 wherein the user interface displays a variable input device for at least one environmental impact parameter which the user interactively adjusts to a value which is provided to the filtering device that only selects products which meet or exceeds this setting value for this environmental impact parameter, the filtering device provided information on the selected products to the user interface for display, effectively displaying or hiding products meeting the criteria as the variable input device is adjusted.

8. The system of claim 6 comprising a plurality of variable input devices each representing a different parameter being considered, and the filtering device is adapted to only display product information for products meeting or exceeding the setting value for all of the parameters being considered.

9. A method for aiding a user in selecting building products for a building project having high environmental sustainability performance and are cost-effective, comprising the steps of:
a. acquiring a database of building products which include cost and environmental sustainability performance information;
b. interacting with the user to define a building project to modify;
c. interacting with the user to define a product type of the building project for which to select a product;
d. acquiring an environmental sustainability benchmark for the defined product type;
allowing the user to define a desired minimum environmental sustainability performance;
e. displaying products from the database that at least meet the desired minimum environmental sustainability performance;
f. allowing the user to select candidate products of the displayed products for further analysis;
g. displaying only the candidate products and their associated environmental sustainability performance information relative to the environmental sustainability benchmark for this product type;
h. allowing the user to select one of the candidate products having higher environmental sustainability performance than others in being displayed for this product type; and
i. storing the selected product to be used in this building project.

10. The method of claim 9 further comprising, after the step of storing the selected product, the step of:
acquiring an amount of the product to be used in the project,
acquiring energy savings/unit time of at least two different products from the database;
comparing the energy savings of at least two different products to estimate an energy savings variance for the products; and
displaying the energy savings/unit time variance to the user.

11. The method of claim 10 further comprising, after the step of displaying energy savings variance, the step of:
acquiring lifecycle costs of at least two different products from the database;
comparing the lifecycle costs of the at least two different products to estimate an cost variance for the products; and
displaying the lifecycle cost variances to the user.

12. The method of claim 11 further comprising the steps of:
calculating how many time units it will take for the energy savings per unit time variance to equal the lifecycle cost variance;
displaying the calculated number of time units as the payback period.

13. The method of claim 9 further comprising, after the step of “i”, storing the selected product, the steps of:
j. repeating steps “c” through “i” of claim 1 for at least one additional product type.

14. The method of claim 13 further comprising, after the step “j”, repeating steps “c” through “i”, the steps of:
repeating steps “b” through “j” of claim 1 for at least one building project.

15. The method of claim 11 further comprising the steps of:
repeating steps “b” through “j” of claim 1 for a comparison building project.

16. The method of claim 15 further comprising the steps of:
calculating lifecycle cost variances between the selected products of the project and the comparison project for each product type.

17. The method of claim 16 further comprising the steps of:
calculating energy savings/unit time variances between the selected products of the project and the comparison project for each product type.

18. The method of claim 16 further comprising the steps of:
determining how many time units it will take for energy saving variances/unit time to equal the lifecycle cost variances, indicating the payback period, and indicating the payback period to the user.

19. The method of claim 9 wherein:
the database is categorized by product types according to a Work Breakdown Structure (WPS).

20. The method of claim 9 wherein:
the database is categorized by product types according to a standard being one of the group consisting of:
a Construction Specification Institute (CSI) code standard and an alternate Work Breakdown Structure standard.
